(19) United States
(12) Patent Application Publication
(10) Pub. No.: US 2014/0149090 A1
(43) Pub. Date: May 29, 2014

(54) Distributed Analysis of Structures

(71) Applicant: Autodesk, Inc., San Rafael, CA (US)

(72) Inventors: Francesco Iorio, Toronto (CA); Pavel Babikov, Toronto (CA)

(73) Assignee: Autodesk, Inc., San Rafael, CA (US)

(21) Appl. No.: 13/829,866

(22) Filed: Mar. 14, 2013

Related U.S. Application Data
(60) Provisional application No. 61/730,449, filed on Nov. 27, 2012.

(51) Int. Cl. G06F 17/50

(52) U.S. Cl. CPC G06F 17/5009
USPC 703/2

(57) ABSTRACT

Methods, systems, and apparatus, including computer programs encoded on a storage medium, for distributed analysis of structures. One of the methods includes obtaining a geometric model of a physical structure; and performing an analysis of a structural characteristic of the physical structure, comprising: dividing, by a master node, the model into a plurality of subdomains using a plurality of separator surfaces, selecting, by the master node, a respective separator approximant for each of the plurality of separator surfaces, assigning each of the subdomains to a respective child node, providing, by the master node to each of the child nodes, information defining the subdomain assigned to the child node and information defining separator approximants for the separator surfaces bordering the subdomain assigned to the child node, and performing, by each child node, the analysis of the structural characteristic for the subdomain assigned to the child node using the information.

### CROSS-REFERENCE TO RELATED APPLICATION

This application claims the benefit under 35 U.S.C. §119(e) of pending U.S. Patent Application No. 61/730,449, filed Nov. 27, 2012, entitled “Distributed Analysis of Structures”, which is incorporated by reference herein in its entirety.

### BACKGROUND

This disclosure relates generally to digital data processing and, in particular, to numerical modeling and simulation tools and techniques.

There are different types of analysis of structures such as, for example, stress analysis, fluid dynamics analysis, electromagnetic analysis, heat transfer analysis, and combined (multiphysical) analysis. These and other types of analysis can be performed by modeling a structure and then solving one or more systems of partial differential equations.

### SUMMARY

In general, one innovative aspect of the subject matter described in this specification can be embodied in methods that include the actions of obtaining a geometric model of a physical structure; and performing an analysis of a structural characteristic of the physical structure, comprising: dividing, by a master node, the model into a plurality of subdomains using a plurality of separator surfaces, selecting, by the master node, a respective separator approximant for each of the plurality of separator surfaces, wherein the separator approximant is a set of two-dimensional functions that approximate fields acting on the separator surface, assigning each of the subdomains to a respective child node, providing, by the master node to each of the child nodes, information defining the subdomain assigned to the child node and information defining separator approximants for the separator surfaces bordering the subdomain assigned to the child node, and performing, by each of the child nodes, the analysis of the structural characteristic for the subdomain assigned to the child node using the information provided to the child node. Other embodiments of this aspect include corresponding systems, apparatus, and computer programs, configured to perform the actions of the methods, encoded on computer storage devices.

These and other embodiments can each optionally include one or more of the following features. The obtaining can further include obtaining data that identifies a distribution of external volume forces, data identifying boundary conditions, and data identifying distributions of material characteristics of the structure. The analysis of the structural characteristic can be a stress analysis.

Each child node can perform the analysis of the subdomain assigned to the child node independently of each other child node. Each child node can select an analysis strategy for performing the analysis for the subdomain assigned to the child node independently of each other child node. Each child node can select a strategy for further decomposition of the subdomain assigned to the child node independently of each other child node. The method can further include preparing, by each of the child nodes, auxiliary data required for constructing the approximation inside of the subdomain assigned to the child node after receiving the information defining the subdomain assigned to the child node from the master node.

Performing the analysis can further include computing, by the master node, a solution to a system of linear equations based on information received from the child nodes. Performing the analysis can further include: detecting, by the master node, from information provided by at least one of a first child node or a second child node, that insufficient accuracy exists at a first separator surface between a first subdomain assigned to the first child node and a second subdomain assigned to the second child node; generating, by the master node, a different approximant for the first separator surface; and providing the different approximant for the first separator surface to the first child node and the second child node for use in place of the separator approximant for the first separator surface. The different approximant can be a finite-element approximation using a preliminary-constructed triangulation of the first separator surface.

Particular embodiments of the subject matter described in this specification can be implemented to realize one or more of the following advantages. The amount of information required to be transferred between nodes of a distributed analysis system can be greatly reduced. A node analyzing a subdomain of a model of a structure can select the method of computing the solution for the subdomain independently of the methods selected by other nodes analyzing other subdomains of the model. Further, the node can also select a strategy for further decomposing the subdomain into additional subdomains independently of the other nodes. Mesh generation for the model can be distributed among multiple different nodes. Additionally, conformal meshing between adjacent subdomains is not required.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example distributed analysis system.

FIG. 2 is a flow diagram of an example technique for dividing a model into subdomains.

FIG. 3 is a flow diagram illustrating an example stress analysis technique.

FIG. 4 is a flow diagram of an example technique for detecting a condition indicative of inaccuracy.

Like reference numbers and designations in the various drawings indicate like elements.

### DETAILED DESCRIPTION

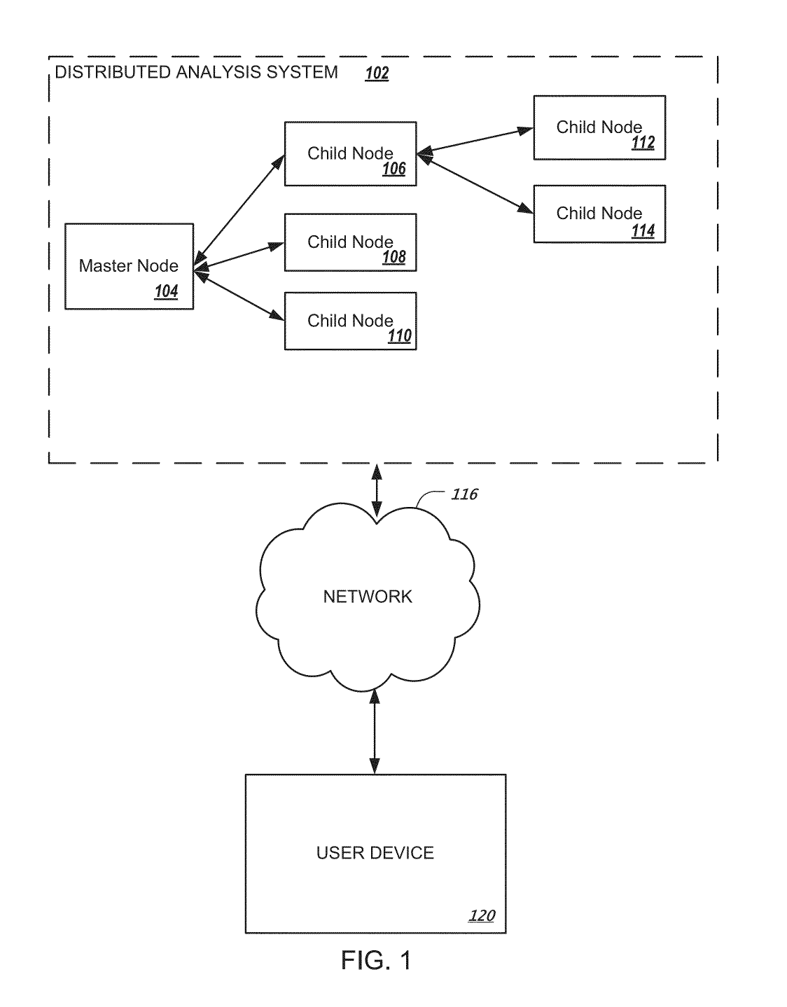

FIG. 1 shows an example distributed analysis system 102. The distributed analysis system 102 is a system implemented as computer programs on one or more data processing apparatus in one or more geographic locations, in which the systems, components, and techniques described below can be implemented.

A user can interact with the distributed analysis system 102 through a user device 120. For example, the user device 120 can be, e.g., a data processing apparatus such as a personal computer, a portable computer, a smart phone, or a tablet computer, coupled to the distributed analysis system 102 through a data communication network 116, e.g., local area network (LAN) or wide area network (WAN), e.g., the Internet, or a combination of networks, any of which may include wireless links.

The distributed analysis system 102 obtains data defining a geometric model of a physical structure, e.g., a building, tunnel, dam, aircraft, and so on, from the user device 120 over the network 116 and performs an analysis of particular characteristics of the structure. A geometric model is a mathematic description of one or more two or three-dimensional shapes (e.g., an explicit representation of points stored in a data structure or procedural representation used to generate the points such as, for example, fractals, straight and curved lines and surfaces, and particle systems). In some implementations, the geometric model is a solid model represented by a solid model scheme (e.g., parameterized primitive instancing, spatial occupancy enumeration, cell decomposition, boundary representation, constructive solid geometry, sweeping, implicit representation, or parametric and feature-based modeling.) Generally, the analysis may be any analysis of a structural characteristic that can be represented by solving a linear, symmetric, positive-definite system of discrete equations approximating original partial differential equations. In particular, the analysis problem can be represented by a boundary value problem for linear differential equations. For example, the analysis can be a stress analysis that determines the distribution of stress in the structure when the structure is subjected to force or a heat transfer analysis that determines temperature and heat flux distributions within the structure. In some implementations, the distributed analysis system 102 also receives additional information that defines the analysis problem. For example, the system can also receive a right hand side vector function for the system of partial differential equations, e.g., that represents a distribution of external volume forces in a stress analysis. The system can also receive data identifying boundary conditions, e.g., data that represents constraints and external boundary loads in a stress analysis. The system can also receive coefficients of equations representing distributions of material characteristics of the structure.

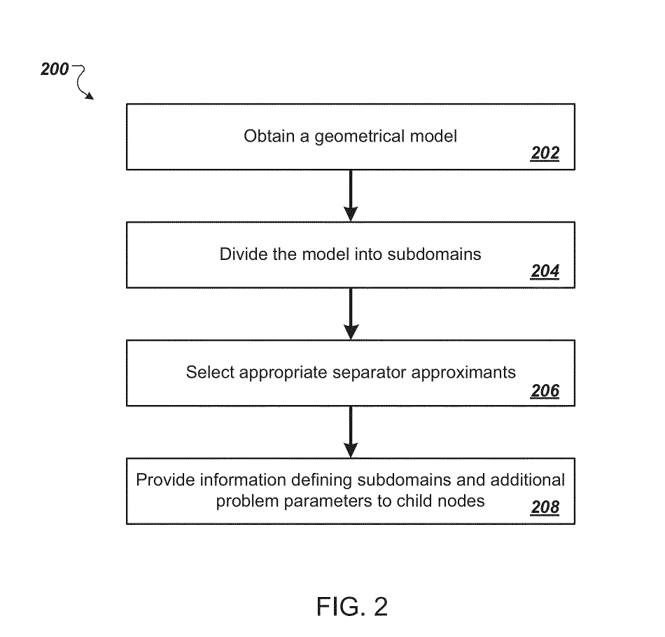

The distributed analysis system 102 performs the analysis by distributing the processing required to perform the analysis among a master node 104 and multiple child nodes 106, 108, 110, 112 and 114. The master node 104 can be implemented as one or more data processing apparatus such as, for example, server computers that each execute one or more computer programs. Generally, the master node 104 divides the geometric model of the structure into subdomains, and provides information defining each subdomain to a child node, e.g., the child nodes 106, 108 and 110, for processing. Dividing the geometric model of the structure into subdomains will be described in more detail below with reference to FIG. 2. As will be described in more detail below, each child node can determine whether to further subdivide the subdomain assigned to the child node. In particular, the child node 106 can determine to subdivide the subdomain assigned to the child node 106 and provide information identifying the subdivisions to child nodes 112 and 114.

The child nodes 106, 108, 110, 112 and 114 can each be implemented as one or more data processing apparatus, e.g., a server computer or a core within a server computer having multiple cores, that each execute as one or more computer. Thus, advantageously, the child nodes 106, 108, 110, 112 and 114 each perform the analysis for the respective subdomain that has been assigned to them independently of the other child nodes. The operation of the master node 104 and the child nodes 106, 108, 110, 112 and 114 is described in more detail below.

FIG. 2 is a flow diagram of an example technique 200 for dividing a model into subdomains. For convenience, the technique 200 will be described with respect to a system including one or more data processing apparatus that performs the technique 200. For example, the technique 200 can be performed by a master node, e.g., the master node 104 of FIG. 1.

The system obtains a geometric model of a structure (step 202). For example, the system can receive data defining a volume that represents the structure, e.g., data defining vertices and parametric edges and faces that form one or more shells that represent the structure. Alternatively, the system can receive data defining the geometry of the structure or a Computer Aided Design (CAD) image of the structure and generate appropriate parametric surfaces that define a volume that represents the structure. The system also obtains additional information, e.g., a right hand side vector function, data identifying boundary conditions, and coefficients of equations representing materials characteristics of the structure.

The system divides the model into subdomains (step 204). That is, the system cuts the volume representing the structure with separator surfaces to generate a set of non-overlapping subdomains, i.e., volumes whose union makes up the volume representing the structure. A separator surface is a surface that separates one subdomain from another. The location of the separator surfaces can be specified manually, e.g., by a user of the user device interacting with the system, or can be selected automatically by the system. For example, the system can divide the model into a pre-determined number of subdomains, into subdomains of pre-determined dimensions, and so on.

The system selects appropriate separator approximants for each separator surface that represents the boundary between two subdomains (step 206). The separator approximants are sets of two-dimensional functions approximating the fields that act on the separator surface. For example, for a stress analysis, the separator approximants can be approximations of the displacement and, optionally, the stress distributions at the separator surface.

The appropriate separator function selected by the system will depend on the implementation, i.e., on the type of analysis being performed, the set of independent variables being used, and on application dependent physical considerations. In the context of stress analysis, for example, once the appropriate separator approximants are selected, the equations for the parameters of the approximants can be derived at least in part from a minimum of a total potential strain energy. The separator approximant can be a set of two-dimensional approximating functions that maximally reduce the number of degrees of freedom needed to approximate displacement and, optionally, stress distributions on the separator surface, while maintaining an accuracy of approximation that satisfies a threshold value.

The system provides information defining a respective subdomain and additional problem parameters to each child node (step 208). That is, the system provides, to each child node, information defining the geometry of the subdomain assigned to the child node. The system also provides additional information, e.g., a right hand side vector function, data identifying boundary conditions, and coefficients of equations representing materials characteristics of the structure. For example, the system can provide a set of vertices and analytic or spline-approximated edges and facets that define the subdomain. Additionally, the system provides, for each of the boundaries of the subdomain, information defining the boundary conditions if the boundary is a native boundary of the structure, the description of the separator approximant selected if the boundary is formed by a separator surface, or both. The boundary conditions for a given boundary can represent, e.g., external loads and constraints applied to that boundary. The system can also provide additional information. The system can also provide other necessary information to the child node, e.g., a right hand side vector function, and coefficients of equations representing materials characteristics of the structure in the subdomain.

Once a child node receives the information defining the respective subdomain assigned to the node, the child node performs one or more iterations of a numerical analysis strategy in order to solve the system of linear partial differential equations for the subdomain assigned to the node. Advantageously, each child node can perform the analysis independent of each other child node. In particular, each child node can select a respective numerical analysis strategy independent of the strategies selected by other child nodes, i.e., the child node can select the numerical analysis strategy that is best suited for the geometry of the subdomain assigned to the node. For example, the child node can select a strategy based on one or more of an analysis of the subdomain geometry, potential presence of singularities within the subdomain, required accuracy for analysis of the subdomain, or estimated computational cost of analyzing the subdomain. For example, depending on the type of structural analysis being performed and the geometry of the subdomain assigned to the node, a given child node can select one of, e.g., a finite element analysis technique, a boundary element analysis technique, a meshless approach, and so on.

In particular, for analysis types that use approximation techniques, e.g., finite element or boundary element analysis, the model of the structure is divided into elements using a meshing process. That is, the geometry of the structure is approximated using a mesh of volumes, e.g., polyhedra. Advantageously, the information defining the respective subdomain assigned to each child node can be provided prior to the meshing process being performed, thereby reducing the amount of information required to be transferred from the master node to the child nodes. That is, because each child node that selects a finite element analysis strategy performs the meshing process for the subdomain assigned to the child node rather than receiving information specifying the finite elements that make up the subdomain from the master node, the amount of information required to be transferred from the master node to the child node is reduced.

Additionally, during the analysis of the structure, matrix complements exchanged between the master node and the child nodes define the response of each of the subdomains to values of parameters of the separator approximants, thus making it possible for the master node to compute the mutual influences each subdomain has on the other subdomains. That is, the matrix complements that are exchanged are compact representations of the response each subdomain exhibits when experiencing loads, displacements, or both on the separator surfaces that bound the subdomains. Because these compact representations of the responses are used, the amount of information required to be transferred between nodes during the analysis process is reduced.

Further, because the analysis within a subdomain is performed independently, in some implementations, a given child node can further divide the subdomain assigned to the node into additional subdomains, with each of the additional subdomains being assigned to a respective child node. In particular, a child node can determine that one or more subdivision criteria are satisfied and, in response, determine to subdivide the subdomain assigned to the node. Generally, the subdivision criteria can be specified to ensure that a single child node is not required to do an excessive amount of processing to generate a solution for the subdomain assigned to the node. For example, the subdivision criteria can include a criterion that specifies that the subdomain be divided if the subdomain exceeds a size threshold. As another example, the subdivision criteria can include a criterion that specifies that the subdomain be divided if the numerical analysis strategy is too slow, too complex, or both. When a child determines that the subdivision criteria are satisfied, the child node can subdivide the subdomain as described above with reference to FIG. 2. That is, the child node can serve as the host node for the child nodes that are assigned subdivisions of the subdomain.

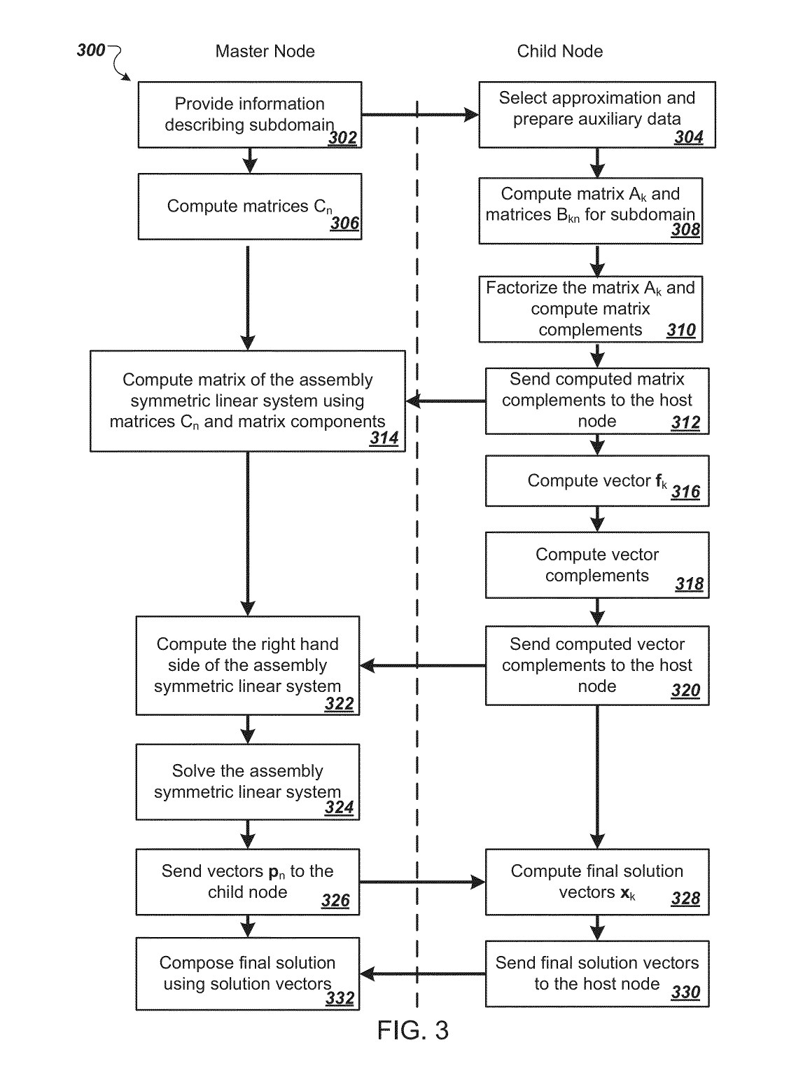

FIG. 3 is a flow diagram illustrating an example stress analysis technique 300. The technique 300 will be described as being performed by a master node, e.g., the master node 104 of FIG. 1, and a child node, e.g., one of child nodes 106, 108, and 110 of FIG. 1.

While the technique 300 will be described as being performed by a single child node for ease of explanation, the technique 300 can be performed in parallel for each of multiple child nodes during a stress analysis process.

The example technique 300 is an example of a technique of solving a simplified stress analysis problem for a model that has been divided into three subdomains k (0, 1, and 2) using two separator surfaces n (0 and 1). However, in practice, the example technique 300 can be used to perform a stress analysis for a model that has been divided into many more subdomains using many more separator surfaces.

Further, while the example technique 300 shows information exchanged between a host node and a child node to solve a stress analysis problem for a model of a physical structure, the technique 300 can be performed to solve the stress analysis problem for a particular subdomain of the model that has been subdivided by the particular child node to which the particular subdomain was assigned into multiple additional subdomains. In these cases, the technique 300 would be performed by exchanging information between the particular child node, which acts as the master node for the particular subdomain, and the child nodes to which the additional subdomains have been assigned.

The simplified stress analysis problem can be represented as two systems of discrete equations. The first system of discrete equations for local displacement fields xₖ inside the subdomains can be expressed as:

A₀ x₀+B₀₀ p₀=f₀

A₁ x₁+B₁₀ p₀+B₁₁ p₁=f₁

A₂ x₂+B₂₁ p₁=f₂,

and the second system of discrete equations for the vectors of parameters pₙ of the selected separator approximants for the two separator surfaces can be expressed as:

B₀₀^{T} x₀+B₁₀^{T} x₁+C₀ p₀=g₀

B₁₁^{T} x₁+B₂₁^{T} x₂+C₁ p₁=g₁,

where Aₖ are square symmetric stiffness matrices representing relationships between nodal displacements or/and stresses inside subdomains, Bₖₙ are auxiliary rectangular matrices representing mutual dependencies of local displacement fields xₖ and separator approximation parameters pₙ, Cₙ are auxiliary square symmetric matrices representing relationships between separator approximation parameters, fₖ are respective vectors of discrete representations of boundary loads and volume forces inside subdomains, and gₙ are vectors of projections of boundary loads and volume forces onto respective separator approximation spaces.

The matrices Bₖₙ, Cₙ, and vectors gₙ can be derived, for example, from the conditions of a minimization of the functional (U−W), where U is the integral potential strain energy and W is work of applied external forces and their respective forms will depend on the selected separator approximants.

The solution of the simplified stress analysis problem has the following form:

x₀=A₀⁻¹ f₀−A₀⁻¹ B₀₀ p₀

x₁=A₁⁻¹ f₁−A₁⁻¹ B₁₀ p₀−A₁⁻¹B₁₁ p₁

x₂ =A₂⁻¹ f₂−A₂⁻¹ B₂₁ p₁,

where the vectors p₀, p₁ are computed as a solution of the assembly symmetric linear system: (C₀−B₀₀^{T} A₀⁻¹ B₀₀−B₁₀^{T} A₁⁻¹ B₁₀) p₀−B₁₀^{T} A₁⁻¹ B₁₁ p₁=g₀−B₀₀^{T} A₀⁻¹ f₀−B₁₀^{T} A₁⁻¹ f₁ B₁₁^{T} A₁⁻¹ B₁₀ p₀+(C₁−B₁₁^{T} A₁⁻¹ B₁₁−B₂₁^{T} A₂⁻¹ B₂₁) p₁=g₁−B₁₁^{T} A₁⁻¹ f₁−B₂₁^{T} A₂⁻¹ f₂

Turning back to the steps of technique 300, the master node provides information describing the subdomain assigned to the child node to the child node (step 302). The information includes information describing the geometry of the subdomain, boundary conditions at the native boundaries of the subdomain, a description of separator approximants selected by the master node for the boundaries of the subdomain formed by separator surfaces, volume forces applied to the subdomain, and volume distribution of material characteristics.

The child node selects an approximation method and prepares auxiliary data required for constructing the approximation inside of the subdomain assigned to the child node (step 304). For example, if required, the child node can perform a meshing process, e.g., to construct two-dimensional local surface grids and three-dimension volume grids for the subdomain.

The host node computes auxiliary square symmetric matrices Cₙ (step 306). The host node computes the auxiliary square symmetric matrices and the vectors based on the given boundary conditions, volume forces, material characteristics, and the selected separator approximants.

The child node computes a stiffness matrix Aₖ for the subdomain assigned to the child node and auxiliary rectangular matrices Bₖₙ for each separator boundary surface of the subdomain assigned to the child node (step 308). The child node factorizes the stiffness matrix Aₖ and computes matrix complements Bₖₙ^{T} Aₖ⁻¹ Bₖₙ for each of the matrices Bₖₙ using the factorized stiffness matrix Aₖ (step 310). The child node then sends the computed matrix complements to the host node (step 312).

The host node receives the matrix complements from the child nodes and computes the matrix of the assembly symmetric linear system (step 314) using the matrices Cₙ and the received matrix complements.

The child node computes the vector fₖ for the subdomain assigned to the node for the given boundary conditions, volume forces, material characteristics, and separator approximants (step 316).

The child node computes vector complements Bₖₙ^{T} Aₖ⁻¹ fₖ using the previously factorized matrices Aₖ (step 318) and sends the computed vector complements to the host node (step 320).

The host node computes the right hand side of the assembly symmetric linear system (step 322) using the previously computed vectors gₙ and the received vector complements.

The host node solves the assembly symmetric linear system using the computed right hand sides and the previously factorized matrix to obtain the vectors of the separator approximant parameters pₙ (step 324).

The host node sends the vectors pₙ that correspond to the boundaries of the subdomain assigned to the child node to the child node (step 326).

The child node receives the vectors pₙ and computes the final solution vectors xₖ by solving the system of equations that represents the solution to the problem (step 328) and sends the solution vector xₖ to the host node (step 330).

The host node uses the solution vectors to compose the final solution of the system of equations, i.e., the final solution of the analysis problem (step 332). That is, the host node receives the solution vectors xₖ, supplements them with solutions on the separator surfaces computed using the vectors pₙ and combines them into the final solution.

In some implementations, the computation of the matrices Cₙ can be delegated to the child nodes, i.e., because those matrices are additive with respect to subdomain responses, so that their respective components can be computed independently by the child and included in matrix complements at step 312. In such implementations, step 306 is not performed by the host node, but distributed among the child nodes.

In some circumstances, during the analysis process the host node can detect a singularity or other condition known to the host node to cause inaccuracies at the boundary between any two vector complements.

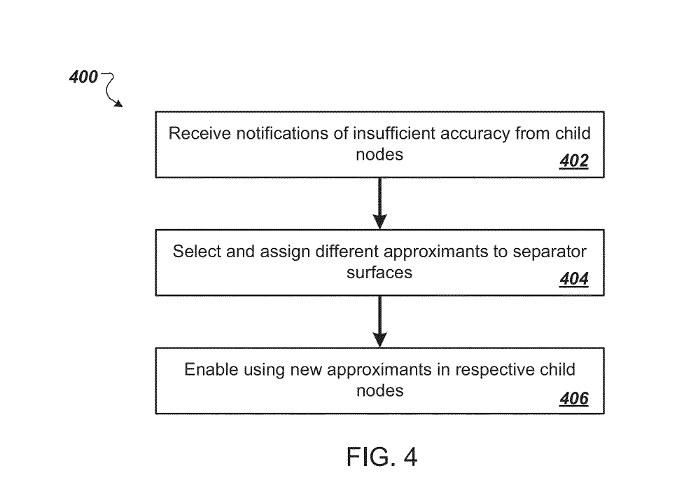

FIG. 4 is a flow diagram of an example technique 400 for detecting a condition indicative of inaccuracy. For convenience, the technique 400 will be described with respect to a system including one or more data processing apparatus that performs the technique 400. For example, the technique 400 can be performed by a master node, e.g., the master node 104 of FIG. 1.

The system receives a notification of insufficient accuracy from child nodes (step 402). That is, the system detects, for each of one or more separator surfaces and from information received from one or more of a pair of child nodes separated by the separator surface, that a condition indicative of inaccuracy is present at the separator surface. For example, the condition can be a singularity caused by geometrical features, discontinuity in material properties, or boundary conditions.

In response to detecting the condition, the system selects and assigns a different approximant to the one or more separator surfaces (step 404). That is, rather than using a separator approximation as described above with reference to FIG. 2, the system can, for example, enable using a standard finite-element approximation of the solution on a preliminary triangulated separator surface.

The system enables using new approximants in the respective child nodes (step 406). For example, the system can provide identifiers identifying the different approximants for the one or more separator surfaces to the pairs of child nodes separated by the separator surfaces for use in analysis of the respective subdomains assigned to the child nodes. Therefore, when conditions exist that prevent the separator approximant from being used with sufficient accuracy, the system can revert to a conventional technique for representing displacement and optionally stress distributions on the surface between any two child nodes.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a CAD model, analytical energy model, simulation results, analysis report) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
obtaining a geometric model of a physical structure; and
performing an analysis of a structural characteristic of the physical structure, comprising:
dividing, by a master node, the model into a plurality of subdomains using a plurality of separator surfaces,
selecting, by the master node, a respective separator approximant for each of the plurality of separator surfaces, wherein the separator approximant is a set of two-dimensional functions that approximate fields acting on the separator surface,
assigning each of the subdomains to a respective child node, providing, by the master node to each of the child nodes, information defining the subdomain assigned to the child node and information defining separator approximants for the separator surfaces bordering the subdomain assigned to the child node, and
performing, by each of the child nodes, the analysis of the structural characteristic for the subdomain assigned to the child node using the information provided to the child node.

2. The method of claim 1, wherein the obtaining further comprises obtaining data that identifies a distribution of external volume forces, data identifying boundary conditions, and data identifying distributions of material characteristics of the structure.

3. The method of claim 1, wherein the analysis of the structural characteristic is a stress analysis.

4. The method of claim 1, wherein each child node performs the analysis of the subdomain assigned to the child node independently of each other child node.

5. The method of claim 1, wherein each child node selects an analysis strategy for performing the analysis for the subdomain assigned to the child node independently of each other child node.

6. The method of claim 1, wherein each child node selects a strategy for further decomposition of the subdomain assigned to the child node independently of each other child node

7. The method of claim 1, further comprising:
preparing, by each of the child nodes, auxiliary data required for constructing the approximation inside of the subdomain assigned to the child node after receiving the information defining the subdomain assigned to the child node from the master node.

8. The method of claim 1, wherein performing the analysis further comprises:
computing, by the master node, a solution to a system of linear equations based on information received from the child nodes.

9. The method of claim 1, wherein performing the analysis further comprises:
detecting, by the master node, from information provided by at least one of a first child node or a second child node, that insufficient accuracy exists at a first separator surface between a first subdomain assigned to the first child node and a second subdomain assigned to the second child node;
generating, by the master node, a different approximant for the first separator surface; and
providing the different approximant for the first separator surface to the first child node and the second child node for use in place of the separator approximant for the first separator surface.

10. The method of claim 9, wherein the different approximant is a finite-element approximation using a preliminary-constructed triangulation of the first separator surface.

11. A system comprising:
one or more data processing apparatus; and
one or more computer-readable storage devices having stored thereon instructions that, when executed by the one or more data processing apparatus, cause the one or more data processing apparatus to perform operations comprising:
obtaining a geometric model of a physical structure; and
performing an analysis of a structural characteristic of the physical structure, comprising:
dividing, by a master node, the model into a plurality of subdomains using a plurality of separator surfaces,
selecting, by the master node, a respective separator approximant for each of the plurality of separator surfaces, wherein the separator approximant is a set of two-dimensional functions that approximate fields acting on the separator surface,
assigning each of the subdomains to a respective child node,
providing, by the master node to each of the child nodes, information defining the subdomain assigned to the child node and information defining separator approximants for the separator surfaces bordering the subdomain assigned to the child node, and
performing, by each of the child nodes, the analysis of the structural characteristic for the subdomain assigned to the child node using the information provided to the child node.

12. The system of claim 11, wherein the obtaining further comprises obtaining data that identifies a distribution of external volume forces, data identifying boundary conditions, and data identifying distributions of material characteristics of the structure.

13. The system of claim 11, wherein the analysis of the structural characteristic is a stress analysis.

14. The system of claim 11, wherein each child node performs the analysis of the subdomain assigned to the child node independently of each other child node.

15. The system of claim 11, wherein each child node selects an analysis strategy for performing the analysis for the subdomain assigned to the child node independently of each other child node.

16. The system of claim 11, wherein each child node selects a strategy for further decomposition of the subdomain assigned to the child node independently of each other child node

17. The system of claim 11, the operations further comprising:
preparing, by each of the child nodes, auxiliary data required for constructing the approximation inside of the subdomain assigned to the child node after receiving the information defining the subdomain assigned to the child node from the master node.

18. The system of claim 11, wherein performing the analysis further comprises:
computing, by the master node, a solution to a system of linear equations based on information received from the child nodes.

19. The system of claim 11, wherein performing the analysis further comprises:
detecting, by the master node, from information provided by at least one of a first child node or a second child node, that insufficient accuracy exists at a first separator surface between a first subdomain assigned to the first child node and a second subdomain assigned to the second child node;
generating, by the master node, a different approximant for the first separator surface; and
providing the different approximant for the first separator surface to the first child node and the second child node for use in place of the separator approximant for the first separator surface.

20. The system of claim 19, wherein the different approximant is a finite-element approximation using a preliminary-constructed triangulation of the first separator surface.
